(19) United States
(12) Patent Application Publication
(10) Pub. No.: US 2026/0310587 A1
(43) Pub. Date: Oct. 8, 2026

(54) GENERATIVE ARTIFICIAL INTELLIGENCE AUTOMATED TESTING FRAMEWORK FOR USER INTERFACES

(71) Applicant: Dell Products L.P., Round Rock, TX (US)

(72) Inventors: Eliyahu Rosenes, Bet Shemesh (IL); Rachel Shalom, Brookline, MA (US); Daniel Ostrovsky, Beit Arye (IL)

(21) Appl. No.: 19/169,046

(22) Filed: Apr. 3, 2025

(51) Int. Cl. G06F 11/3668

(52) U.S. Cl. CPC G06F 11/3684; G06F 11/3688

(57) ABSTRACT

A method for generating end-to-end (E2E) tests for a user interface (UI) of a web application, the method includes receiving, from a code repository, data test IDs associated with actionable UI elements of the UI and source code, rendering the UI using the source code, collecting all actionable UI elements associated with the data test IDs from the rendered UI, and generating page objects using the collected actionable UI elements. Further, the method includes receiving a data test plan, where the data test plan comprises a natural language input, and generating the E2E tests based on page objects and the data test plan, where the E2E tests are executable by a testing framework.

### BACKGROUND

Users often interact with web applications via the web application's user interface (UI). UIs are often composed of various UI elements such as buttons, menus, and input fields, along with elements that are hidden within layers beyond an initial UI. These hidden layers often remain inaccessible or unnoticed until the user engages with the UI. Thoroughly testing the UI is important to ensure a smooth and reliable user experience. Exposing these hidden elements can enhance UI testing by allowing for more comprehensive evaluation and interaction.

### BRIEF DESCRIPTION OF DRAWINGS

Certain embodiments of the disclosure will now be described with reference to the accompanying drawings. However, the accompanying drawings illustrate only certain aspects or implementations of the disclosure by way of example and are not meant to limit the scope of the claims.

FIG. 1 shows a diagram of a system in accordance with one or more embodiments.

FIG. 2 shows a flowchart of a method for collecting actionable UI elements associated with data test IDs from a rendered UI in accordance with one or more embodiments.

FIG. 3 shows a flowchart of a method for generating end-to-end (E2E) tests for a UI of a web application in accordance with one or more embodiments.

FIG. 4 shows a diagram of a computing system in accordance with one or more embodiments.

### DETAILED DESCRIPTION

In the realm of web application development, ensuring a seamless and error-free user experience is paramount. This necessitates rigorous end-to-end (E2E) testing of user interfaces (UI) to simulate real-world usage. However, the process of creating, maintaining, and updating E2E tests presents significant challenges, particularly when attempting to leverage artificial intelligence (AI) for automation. These challenges include complex abstraction layers, dynamic content and state management, diverse user interaction, visual rendering across devices and browsers, and maintenance and scalability. Inherent abstraction layers between source code of a web application and its final rendered UI in a browser complicate the AI's ability to directly generate and interact with E2E tests. The dynamic nature of modern web applications, which often include asynchronous data loading and interactive elements, further exacerbates this issue.

Additionally, modern web applications frequently update their content and state dynamically, without full page reloads. This dynamic behavior, driven by user interactions and real-time data updates, makes it difficult for AI to predict and understand the UI's state at any given moment, complicating the test generation process.

Moreover, real-world use of web applications involves complex user interactions, such as clicking, typing, drag-and-drop actions, multi-touch gestures, and more. Accurately simulating these interactions in E2E tests is a non-trivial task for AI due to the wide range of possible actions and their effects on the application state.

In addition, the final UI that users interact with is the result of multiple layers of styling and layout, which can vary significantly across different browsers and devices. Ensuring consistent behavior and appearance across these platforms is crucial for comprehensive testing but presents a significant challenge for AI-driven test generation.

Further, as web applications evolve, their UIs change, necessitating updates to E2E tests to ensure they remain relevant and effective. The manual effort required to maintain and scale these tests in line with application changes is substantial, making the process time-consuming and prone to human error.

To address the challenges referenced above, the disclosure introduces a solution designed to revolutionize the process of creating and maintaining UI E2E tests for web applications. By leveraging a generative AI model (the “Model”), this solution overcomes the limitations of existing methods, offering a more efficient, accurate, and scalable approach to automated testing.

The solution employs data test IDs across UI elements to serve as clear markers, enabling precise identification and interaction by the Model. This ensures that every element can be accurately referenced and manipulated. Further, the system is configured to recognize the dynamic nature of modern web applications, the solution utilizes both browser rendering and server-side rendering to capture the UI in its fully interactive state. This is done by creating a browser plugin that scrapes the UI elements from a web application page once the page is rendered. After the UI elements are scraped, this plugin sends the raw data of these elements to the Model, enabling it to receive that full dynamic content as viewed by a human application user.

Additionally, the system uses the Model to analyze the rendered UI and generate page objects. These page objects act as an abstraction layer, translating the complex UI into a structured and understandable format for the AI. This step bridges the gap between the raw UI and the testable components, enabling the Model to generate meaningful and effective E2E tests.

Moreover, the system leverages the detailed page objects and test plans provided by an administrative system, the Model then proceeds to generate comprehensive E2E tests. These tests are designed to simulate real-world user interactions, validate functionality across various scenarios, and ensure the application behaves as expected.

Specific embodiments will now be described with reference to the accompanying figures.

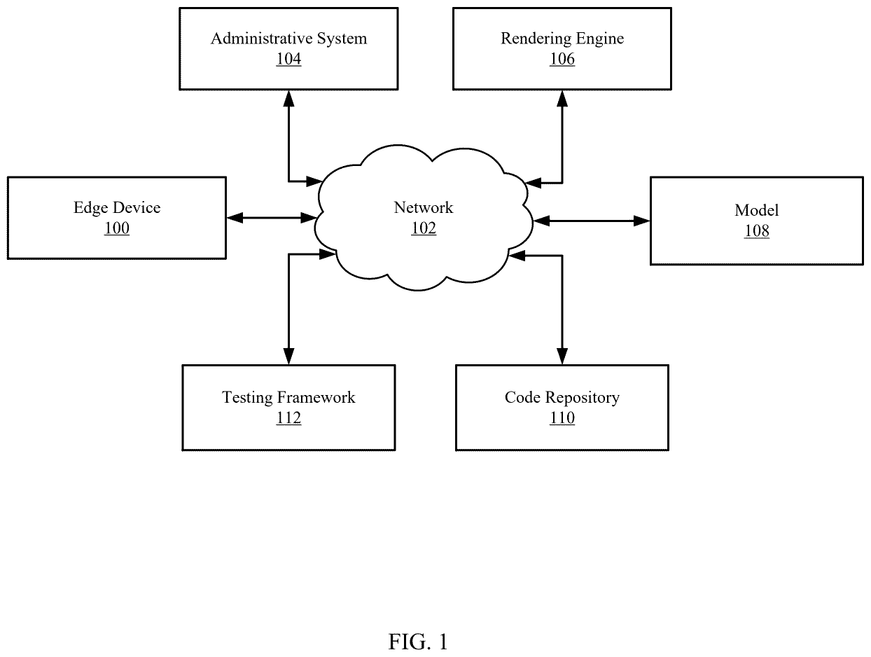

FIG. 1 shows a system in accordance with one or more embodiments. The system may include an edge device (100), a network (102), an administrative system (104), a rendering engine (106), a model (108), a code repository (110), and a testing framework (112). The system may include additional, fewer, and/or different components without departing from the scope of the embodiments disclosed herein. Each component may be operably/operatively connected to any of the other components via any combination of wired and/or wireless connections. Each of these system components is described below.

In one or more embodiments, the edge device (100), the administrative system (104), the rendering engine (106), the model (108), the code repository (110), and the testing framework (112), may be operatively connected to one another through the network (102) (e.g., a local area network (LAN), a wide area network (WAN) such as the Internet, a mobile network, any other network type, or a combination thereof). Further, the network (102) may encompass various interconnected, network-enabled subcomponents (or systems) (e.g., switches, routers, gateways, etc.) that may facilitate communications between the aforementioned components. Moreover, the edge device (100), the administrative system (104), the rendering engine (106), the model (108), the code repository (110), and the testing framework (112) may communicate with one another using any combination of wired and/or wireless communication protocols.

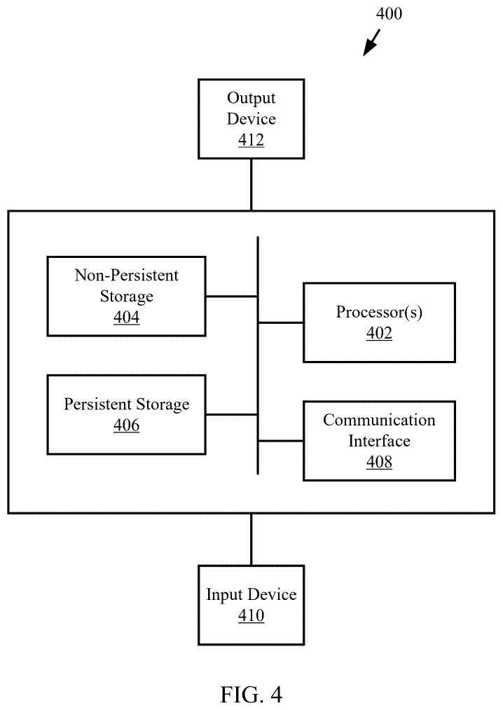

In one or more embodiments, the edge device (100) may be a physical device such as a personal computing system (e.g., a laptop, a cell phone, a tablet computer, a server, etc.) configured for hosting one or more workloads, or for providing a computing environment whereon workloads may be implemented. For example, the edge device (100) may be a computing system (e.g., 400, FIG. 4) as discussed below in more detail in FIG. 4. In one or more embodiments, the edge device (100) may include a user interface (e.g., a graphical user interface) (not shown) that allows a user to interact with applications running on the edge device (100).

In one or more embodiments, the edge device (100) may include any number of applications (and/or content accessible through the applications) that provide computer-implemented services to a user. In one or more embodiments, the applications may include but should not be limited to, word processing applications, spreadsheet applications, email applications/clients, database applications, presentation applications, calendar applications, etc. Applications may be designed and configured to perform one or more functions instantiated by a user of the edge device (100). In order to provide application services, each application may host similar or different components. The components may be, for example (but not limited to), instances of databases, instances of email servers, etc. Applications may be executed on one or more edge device(s) (100) as instances of the application.

Applications may vary in different embodiments, but in certain embodiments, applications may be custom-developed or commercial (e.g., off-the-shelf) applications that a user desires to execute on the edge device (100). In one or more embodiments, applications may be logical entities executed using computing resources of the edge device (100). For example, applications may be implemented as computer instructions stored on persistent storage of the edge device (100) that when executed by the processor(s) of the edge device (100), cause the edge device (100) to provide the functionality of the applications described throughout the application.

In one or more embodiments, while performing, for example, one or more operations requested by a user, applications installed on the edge device (100) may include functionality to request and use physical and logical resources of the edge device (100). Applications may also include functionality to use data stored in storage/memory resources of the edge device (100). The applications may perform other types of functionalities not listed above without departing from the scope of the embodiments disclosed herein. While providing application services to a user, applications may store data that may be relevant to the user in storage/memory resources of the edge device (100).

In one or more embodiments, to provide services to the users, the edge device (100) may utilize, rely on, or otherwise cooperate with an infrastructure node (IN) (not shown). For example, the edge device (100) may issue requests to the IN to receive responses and interact with various components of the IN. The edge device (100) may also request data from and/or send data to the IN (for example, the edge device (100) may transmit information to the IN that allows the IN to perform computations, the results of which are used by the edge device (100) to provide services to the users). As yet another example, the edge device (100) may utilize computer-implemented services provided by the IN. When the edge device (100) interacts with the IN, data that is relevant to the edge device (100) may be stored (temporarily or permanently) in the IN.

In one or more embodiments, the edge device (100) may be capable of, for example: (i) collecting users' inputs, (ii) correlating collected users' inputs to the computer-implemented services to be provided to the users, (iii) communicating with INs that perform computations necessary to provide the computer-implemented services, (iv) using the computations performed by the infrastructure nodes to provide the computer-implemented services in a manner that appears (to the users) to be performed locally to the users, and/or (v) communicating with any virtual desktop (VD) in a virtual desktop infrastructure (VDI) environment (or a virtualized architecture) provided by the IN (using any known protocol in the art), for example, to exchange remote desktop traffic or any other regular protocol traffic (so that, once authenticated, users may remotely access independent VDs).

As described above, the edge devices (100) may provide computer-implemented services to users (and/or other computing devices). The edge devices (100) may provide any number and any type of computer-implemented services. To provide computer-implemented services, an edge device (100) may include a collection of physical components (e.g., processing resources, storage/memory resources, networking resources, etc.) configured to perform operations of the edge device (100) and/or otherwise execute a collection of logical components (e.g., virtualization resources) of the edge device (100).

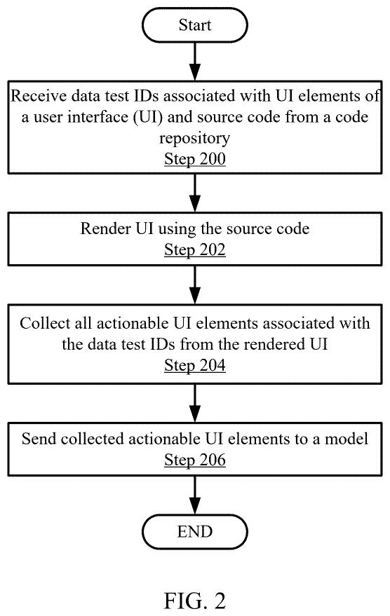

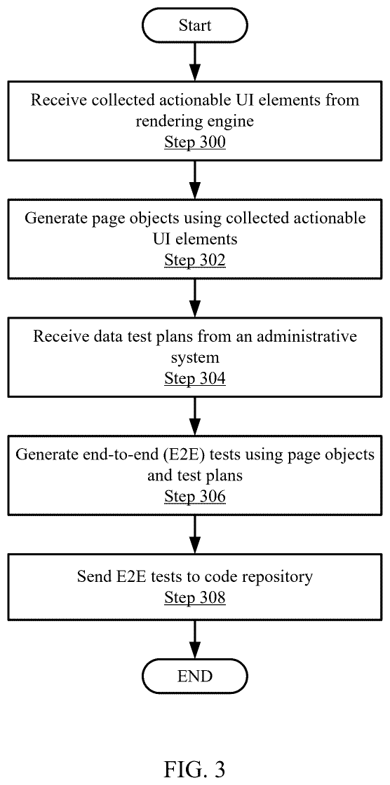

Further, the edge device (100) may include functionality to perform at least a portion of the methods shown in FIGS. 2-3. One of ordinary skill in the art will appreciate that the edge device (100) may perform other functionalities without departing from the scope of the embodiment disclosed herein.

In one or more embodiments, the administrative system (104) includes the functionality to generate the test plans and assign data test IDs to relevant UI elements. In one or more embodiments, the test plans refer to a roadmap that defines the scope, focus areas, and objective of the E2E tests. In one or more embodiments, the model (108) also uses past E2E tests to generate the E2E tests. In one or more embodiments, UI elements refer to elements within web applications that users interact with to navigate or perform actions within the web application, including but not limited to buttons, text fields, buttons, toggles, menus, etc. In one or more embodiments, the data test IDs are used to mark UI elements relevant to the test plans. In a non-limiting example, if the test plans focus on testing the UI in a login page, there may be data test IDs for at least the username text field, password text field, and the submit button. Further, the administrative system (104) may include functionality to perform at least a portion of the methods shown in FIGS. 2-3. One of ordinary skill in the art will appreciate that the administrative system (104) may perform other functionalities without departing from the scope of the embodiment disclosed herein.

In one or more embodiments, the rendering engine (106) includes the functionality to expose and collect all actionable UI elements from web applications. In one or more embodiments, actionable UI elements refer to all UI elements that have been assigned data test IDs and UI elements that have not been assigned test IDs but are needed for the UI to function correctly. In one or more embodiments, some UI elements only appear after a user interacts with the UI. In one or more embodiments, some UI elements are sourced from different sources and are only retrieved after the UI is fully rendered or certain interactions are performed within the UI. In one or more embodiments, the rendering engine (106) collects all of the UI elements by systematically rendering all possible states of web applications, thereby simulating user interactions to expose all of the UI elements. In one or more embodiments, the rendering engine (106) can perform both server-side rendering and browser-side rendering. In one or more embodiments, the rendering engine (106) is a browser-based plugin (i.e., software that adds new features or functionality to a web browser). Further, the rendering engine (106) may include functionality to perform at least a portion of the methods shown in FIGS. 2-3. One of ordinary skill in the art will appreciate that the rendering engine (106) may perform other functionalities without departing from the scope of the embodiment disclosed herein.

In one or more embodiments, the model (108) includes the functionality to generate end-to-end (E2E) tests. In one or more embodiments, the E2E tests, test the capabilities of a UI by simulating real-world usage. In one or more embodiments, the E2E tests are generated using test plans and page objects (i.e., abstractions that encapsulate the UI elements and behaviors of the UI elements that form an abstraction layer that presents the UI as a structured and understandable format for the model (108)). In one or more embodiments, the page objects are also generated by the model (108). In one or more embodiments, the model (108) that generates the page objects is distinct from the model (108) that generates the E2E tests. In one or more embodiments, the model (108) may be a large language model (LLM). In one or more embodiments, the LLM may be any LLM known in the art or discovered in the future. In one or more embodiments, the model (108) may be a deep learning model (DLM). In one or more embodiments, a DLM may be a machine learning and/or artificial intelligence paradigm (e.g., a neural network, a decision tree, a support vector machine, etc.). Any DLM may be defined through a set of parameters and/or hyper-parameters that may be optimized or tuned to assure the optimal performance of a function. A parameter may refer to a configuration variable that is internal to the DLM and whose value may be estimated from data. Examples of a parameter include, but are not limited to, the weights in a neural network, and the support vectors in a support vector machine. In contrast, a hyper-parameter may refer to a configuration variable that is external to the DLM and whose value may not be estimated from data. Examples of a hyper-parameter include, but are not limited to, the learning rate for training a neural network, and the soft margin cost function for a nonlinear support vector machine. Further, any DLM may be further defined through other architectural elements, which may vary depending on the paradigm based on which the DLM may be modeled.

In one or more embodiments, a DLM may be optimized through supervised learning. Supervised learning may refer to learning (or optimization) through the analyses of training examples and/or data. One of ordinary skill will appreciate that other learning methodologies (e.g., unsupervised learning) may be used to optimize a DLM without departing from the scope of the disclosure. Substantively, in one or more embodiments, a DLM may include functionality to: receive input data (e.g., page objects, tests plans, performance data from past E2E tests, etc.); process the input data using an optimized set of architectural element values; and produce output data (e.g., E2E tests, page objects, etc.) based on the processing.

Further, the model (108) may include functionality to perform at least a portion of the methods shown in FIGS. 2-3. One of ordinary skill in the art will appreciate that the model (108) may perform other functionalities without departing from the scope of the embodiment disclosed herein.

In one or more embodiments, the code repository (110) includes the functionality to store data (e.g., computer readable code, natural language text, etc.). The code repository (110) may utilize volatile storage, non-volatile storage, or any combination thereof. Examples of storage include (but are not limited to): a hard disk drive (HDD), a solid-state drive (SSD), random access memory (RAM), flash memory, a tape drive, a fibre-channel (FC) based storage device, a floppy disk, a diskette, a compact disc (CD), a digital versatile disc (DVD), a non-volatile memory express (NVMe) device, a NVMe over Fabrics (NVMe-oF) device, resistive RAM (ReRAM), persistent memory (PMEM), virtualized storage, and virtualized memory. In one or more embodiments, the code repository (110) may be operably connected to the edge device (100). Further, the code repository (110) may include functionality to perform at least a portion of the methods shown in FIGS. 2-3. One of ordinary skill in the art will appreciate that the code repository (110) may perform other functionalities without departing from the scope of the embodiment disclosed herein.

In one or more embodiments, the testing framework (112) includes the functionality to execute E2E tests. In one or more embodiments, executing the E2E tests refers to simulating user interactions (e.g., clicking, typing, drag-and-drop actions, multi-touch gestures, etc.) with UI elements of web applications to validate that the UI and underlying systems function correctly. It should be appreciated, that the scope of the UI elements tested will depend on the test plans and the data test IDs that the model (108) is given by the administrative system (104). In one or more embodiments, the testing framework (112) may execute the E2E tests by any means known in the art or discovered in the future. Further, the testing framework (112) may include functionality to perform at least a portion of the methods shown in FIGS. 2-3. One of ordinary skill in the art will appreciate that the testing framework (112) may perform other functionalities without departing from the scope of the embodiment disclosed herein.

In one or more embodiments, the edge device (100), the administrative system (104), the rendering engine (106), the model (108), the code repository (110), and the testing framework (112) are each implemented as a computing device (see e.g., FIG. 4). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid-state drives, etc.). The computing device may include instructions, stored on the persistent storage, that when executed by the processor(s) of the computing device cause the computing device to perform the functionality of the edge device (100), the administrative system (104), the rendering engine (106), the model (108), the code repository (110), and the testing framework (112) described throughout this application.

In one or more embodiments, the edge device (100), the administrative system (104), the rendering engine (106), the model (108), the code repository (110), and the testing framework (112) each implemented as a logical device. The logical device may utilize the computing resources of any number of computing devices and thereby provide the functionality of the edge device (100), the administrative system (104), the rendering engine (106), the model (108), the code repository (110), and the testing framework (112).

Turning to FIG. 2, FIG. 2 shows a flowchart of a method for collecting actionable UI elements associated with data test IDs from a rendered user interface (UI) in accordance with one or more embodiments disclosed herein. The method may be performed by, for example, a rendering engine (e.g., 106 in FIG. 1). Other components in the system may perform this method without departing from the scope of the disclosure.

In step 200, the rendering engine (e.g., 106 in FIG. 1) receives data test IDs associated with UI elements of a user interface (UI) of a web application (i.e., software accessed and run through a web browser) and source code of the web application from a code repository (e.g., 110 in FIG. 1). In one or more embodiments, UI elements refer to elements within web applications that users interact with to navigate or perform actions within the web application, including but not limited to buttons, text fields, toggles, menus, etc. In one or more embodiments, the data test IDs are used to mark UI elements relevant to the test plans (i.e., a roadmap that defines the scope, focus areas, and objective of end-to-end (E2E) tests). In one or more embodiments, E2E tests refer to tests that verify the complete functionality of the UI by simulating a user's entire journey through the web application, from start to finish, interacting with all visible UI elements and features to ensure a seamless user experience across the entire web application. In one or more embodiments, source code refers to the underlying computer readable code that defines and controls structure, appearance, and behavior of the UI. In one or more embodiments, the source code may be in any language including but not limited to HTML, CSS, JavaScript, etc. In one or more embodiments, an administrative system (e.g., 104 in FIG. 1) assigns the data test IDs to the UI elements. In a non-limiting example, if the test plans focus on testing a login page UI, there may be test IDs for at least a username text field, a password text field, and a submit button. In one or more embodiments, the rendering engine (e.g., 106 in FIG. 1) may receive the data test IDs and the source code by any means known in the art or discovered in the future.

In step 202, the rendering engine (e.g., 106 in FIG. 1) renders the web application UI using the source code to expose actionable UI elements associated with the data test IDs. In one or more embodiments, actionable UI elements refer to all elements that have been assigned data test IDs and elements that have not been assigned test IDs but are needed for the UI to function correctly. It should be appreciated, that UI often includes multiple layers of styling and layout, which can vary significantly across different browsers and devices. It should be further appreciated, that the multiple layers of the UI can originate from multiple data sources, including but not limited to local states, back-end services, real-time data streams, and third-party systems. Additionally, it should be appreciated, that this makes the UIs hard to test due to the large variation of hidden and differently defined UI elements. Further, it should be appreciated, that UI is constantly updated, resulting in new elements that may not have been assigned data test IDs or anticipated when the test plans were created. Thus, by rendering the UI, the rendering engine (e.g., 106 in FIG. 1) exposes all of the UI elements needed for the UI to function correctly. Continuing with the example in step 200, rendering the UI may expose a notification box in the UI indicating an incorrect username or password entry, which includes a button that users must click to proceed to reenter the username and password on the login page. Because the button required for the UI to function correctly, it would also be an actionable element along with the username field, the password field, and the submit button.

In step 204, the rendering engine (e.g., 106 in FIG. 1), collects all actionable UI elements associated with the data test IDs from the rendered UI. In one or more embodiments, the rendering engine (e.g., 106 in FIG. 1) collects all the actionable UI elements by any means known in the art or discovered in the future.

In step 206, the rendering engine (e.g., 106 in FIG. 1) sends the collected actionable UI elements to a model (e.g., 108 in FIG. 1). In one or more embodiments, the rendering engine (e.g., 106 in FIG. 1) sends the collected actionable UI elements to the model (e.g., 108 in FIG. 1) by any means known in the art of discovered in the future. Further, in generating and sending the collected actionable UI elements, the rendering engine generates a dataset that is representative of an actual user experience, which enables tests to be more precise in targeting and validating UI elements and user interactions while also reducing the likelihood of false positives and negatives. In addition, these collected actionable UI elements can be quickly updated to reduce overhead for future tests and enable testing of a quickly growing application.

In one or more embodiments, the method may end following step 206.

Turning to FIG. 3, FIG. 3 shows a flowchart of a method for generating end-to-end (E2E) tests for a user interface (UI) of a web application in accordance with one or more embodiments disclosed herein. The method may be performed by, for example, a model (e.g., 108 in FIG. 1). Other components in the system may perform this method without departing from the scope of the disclosure.

In step 300, the model (e.g., 108 in FIG. 1) receives collected actionable UI elements from a rendering engine (e.g., 106 in FIG. 1). In one or more embodiments, UI elements refer to elements within web applications that users interact with to navigate or perform actions within the web application, including but not limited to buttons, text fields, buttons, toggles, menus, etc. In one or more embodiments, actionable UI elements refer to all UI elements that have been assigned test IDs and elements that have not been assigned test IDs but are needed for a UI to function correctly.

In step 302, the model (e.g., 108 in FIG. 1) generates page objects (i.e., abstractions that encapsulate the UI elements and behaviors of the UI elements that form an abstraction layer that presents the UI as a structured and understandable format for the model (e.g., 108 in FIG. 1)) using the collected actionable UI elements. In one or more embodiments, the model (e.g., 108 in FIG. 1) is a model that was trained on a computer readable code, examples of such models include but are not limited to LLaMA™, CodeLLaMA™, StarCoder™, CodeGemma™, etc. In one or more embodiments, the page objects may be presented by the model (e.g., 108 in FIG. 1) in the form of computer readable code for a testing framework (e.g., 112 in FIG. 1) including but not limited to Cypress™, Selenium™, Puppeteer™, WebDriverIO™, Nightwatch.js™, etc. In one or more embodiments, the model (e.g., 108 in FIG. 1) is a deep learning model (DLM) as described in FIG. 1. In one or more embodiments, the model (e.g., 108 in FIG. 1) may generate the page objects by any means known in the art or discovered in the future.

In step 304, the model (e.g., 108 in FIG. 1) receives test plans from an administrative system (e.g., 104 in FIG. 1). In one or more embodiments, test plans refer to a roadmap that defines the scope, focus areas, and objective of E2E tests that the model (e.g., 108 in FIG. 1) uses to develop the E2E tests. In one or more embodiments, E2E tests refer to tests that verify the complete functionality of the UI by simulating a user's entire journey through the web application, from start to finish, interacting with all visible UI elements and features to ensure a seamless user experience across the entire web application. In one or more embodiments, the test plans include natural language text, computer-readable code, or a combination thereof. In one or more embodiments, the test plans are created by an administrative system (e.g., 104 in FIG. 1). In one or more embodiments, the test plans are created by any means known in the art or discovered in the future. Continuing with the non-limiting example in step 202, the data test plan may include instructions to test the UI of a login page on a web application.

In step 306, the model (e.g., 108 in FIG. 1) generates E2E tests using the page objects and the test plans. In one or more embodiments, the E2E tests include natural language text, computer-readable code, or a combination thereof. In one or more embodiments, the format and structure of the E2E tests depend on the testing framework (e.g., 112 in FIG. 1) that will be used to execute the E2E tests. In one or more embodiments, the testing frameworks (e.g., 112 in FIG. 1) include but are not limited to Cypress™, Selenium™, Puppeteer™, WebDriverIO™, Nightwatch.js™, etc. In one or more embodiments, the model (e.g., 108 in FIG. 1) is an LLM. In one or more embodiments, the model (e.g., 108 in FIG. 1) is a DLM as described in FIG. 1. In one or more embodiments, the model (e.g., 108 in FIG. 1) that generates the page objects in step 302, is distinct from the model (e.g., 108 in FIG. 1) that generates the E2E tests. In one or more embodiments, the model (e.g., 108 in FIG. 1) may use past E2E tests along with the page objects and the test plans to generate the E2E tests. It should be appreciated, that using previous E2E tests results in continuous learning and ensures that the testing framework (e.g., 112 in FIG. 1) remains effective and efficient as web applications evolve, reducing the maintenance burden and enhancing the E2E tests coverage over time. In one or more embodiments, once the UI changes the model (e.g., 108 in FIG. 1) generates a new E2E test using past the E2E tests, the page objects, and the test plans. In one or more embodiments, the model (e.g., 108 in FIG. 1) constantly monitors for changes in the UI. In one or more embodiments, the model (e.g., 108 in FIG. 1) may generate the E2E tests by any means known in the art or discovered in the future. Continuing with the non-limiting example in step 304, a E2E test for a login page may be as follows: (1) visit login page; (2) enter a valid username in username field; (3) enter a valid password in password field; (4) click login button; and (5) verify that login is successful, and the user is redirected to a dashboard.

In step 308, the model (e.g., 108 in FIG. 1) sends the E2E tests to a code repository. In one or more embodiments, the model (e.g., 108 in FIG. 1) sends the E2E tests to a code repository (e.g., 110 in FIG. 1) by any means known in the art or discovered in the future. In one or more embodiments, the model (e.g., 108 in FIG. 1) sends the E2E tests to a testing framework (e.g., 112 in FIG. 1) to execute the E2E test. In one or more embodiments, executing the E2E tests refers to simulating user interactions (e.g., clicking, typing, drag-and-drop actions, multi-touch gestures, etc.) with UI elements of web applications to validate that the UI and underlying systems function correctly. In one or more embodiments, an edge device (e.g., 100 in FIG. 1) presents results of the executed E2E test to a user via a graphical user interface (GUI).

In one or more embodiments, the method may end following step 308.

Embodiments of the disclosure may be implemented using computing devices. Turning to FIG. 4, FIG. 4 shows a diagram of a computing device (400) in accordance with one or more embodiments. The computing device (400) may include one or more computer processor(s) (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (408) (e.g., Bluetooth interface, infrared interface, network interface, optical interface, etc.), input devices (410), output devices (412), and numerous other elements (not shown) and functionalities. Each of these components is described below.

In one embodiment, the computer processor(s) (402) may be an integrated circuit for processing instructions. For example, the computer processor(s) (402) may be one or more cores or micro-cores of a processor. The computing device (400) may also include one or more input devices (410), such as a touchscreen, access keyboard, mouse, microphone, touchpad, electronic pen, or any other type of input device. The communication interface (408) may include an integrated circuit for connecting the computing device (400) to a network (e.g., 102 in FIG. 1) (e.g., a local area network (LAN), a wide area network (WAN) such as the Internet, mobile network, or any other type of network) and/or to another device, such as another computing device.

In one embodiment, the computing device (400) may include one or more output devices (412), such as a screen (e.g., a liquid crystal display (LCD), a plasma display, touchscreen, cathode ray tube (CRT) monitor, projector, or other display device), a printer, external storage, or any other output device. One or more of the output devices (412) may be the same or different from the input devices (410). The input and output device(s) (410, 412) may be locally or remotely connected to the computer processor(s) (402), non-persistent storage (404), and persistent storage (406). Many diverse types of computing devices exist, and the aforementioned input and output device(s) (410, 412) may take other forms.

The problems discussed above should be understood as being examples of problems solved by embodiments of the disclosure and the disclosure should not be limited to solving the same/similar problems. The disclosed disclosure is broadly applicable to address a range of problems beyond those discussed herein.

In the detailed description of the embodiments of the disclosure above, numerous specific details are set forth in order to provide a more thorough understanding of one or more embodiments of the disclosure. However, it will be apparent to one of ordinary skill in the art that the one or more embodiments of the disclosure may be practiced without these specific details. In other instances, well-known features have not been described in detail to avoid unnecessarily complicating the description.

In the prior description of the figures, any component described with regard to a figure, in various embodiments of the disclosure, may be equivalent to one or more like-named components described with regard to any other figure. For brevity, descriptions of these components are not repeated with regard to each figure. Thus, each and every embodiment of the components of each figure is incorporated by reference and assumed to be optionally present within every other figure having one or more like-named components. Additionally, in accordance with various embodiments of the disclosure, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, throughout this application, elements of figures may be labeled as A to N. As used herein, the aforementioned labeling means that the element may include any number of items and does not require that the element include the same number of elements as any other item labeled as A to N unless otherwise specified. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

Software instructions in the form of computer readable program code to perform embodiments described herein may be stored, in whole or in part, temporarily or permanently, on a non-transitory computer readable medium such as a CD, DVD, storage device, a diskette, a tape, flash memory, physical memory, or any other physical computer readable storage medium. Specifically, the software instructions may correspond to computer readable program code that, when executed by a processor(s), is configured to perform one or more embodiments described herein.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims below.

What is claimed is:

1. A method for generating end-to-end (E2E) tests for a user interface (UI) of a web application, the method comprising:
receiving, from a code repository, data test IDs associated with UI elements of the UI and source code;
rendering the UI using the source code;
collecting all actionable UI elements associated with the data test IDs from the rendered UI;
generating page objects using the collected actionable UI elements;
receiving a data test plan, wherein the data test plan comprises a natural language input; and
generating the E2E tests based on page objects and the data test plan, wherein the E2E tests are executable by a testing framework.

2. The method of claim 1, further comprising:
sending the E2E tests to the testing framework; and
executing the E2E tests using the testing framework to generate a set of test results.

3. The method of claim 2, wherein a first model generates the page objects and a second model generates the E2E tests.

4. The method of claim 3, wherein the E2E tests and the set of test results are used to train the second model.

5. The method of claim 3, wherein the second model comprises a Large Language Model (LLM).

6. The method of claim 1, wherein rendering comprises pulling actionable UI elements from a plurality of data sources.

7. The method of claim 6, wherein the actionable UI elements are collected from the plurality of data sources.

8. The method of claim 1, wherein the collecting is performed by a browser-based plugin.

9. A non-transitory computer readable medium (CRM) comprising computer readable program code, which when executed by a computer processor, enables the computer to perform a method for generating end-to-end (E2E) tests for a user interface (UI) of a web application, the method comprising:
receiving, from a code repository, data test IDs associated with UI elements of the UI and source code;
rendering the UI using the source code;
collecting all actionable UI elements associated with the data test IDs from the rendered UI;
generating page objects using the collected actionable UI elements;
receiving a data test plan, wherein the data test plan comprises a natural language input; and
generating the E2E tests based on page objects and the data test plan, wherein the E2E tests are executable by a testing framework.

10. The non-transitory CRM of claim 9, further comprising:
sending the E2E tests to the testing framework; and
executing the E2E tests using the testing framework to generate a set of test results.

11. The non-transitory CRM of claim 10, wherein a first model generates the page objects and a second model generates the E2E tests.

12. The non-transitory CRM of claim 11, wherein the E2E tests and the set of test results are used to train the second model.

13. The non-transitory CRM of claim 11, wherein the second model comprises a Large Language Model (LLM).

14. The non-transitory CRM of claim 9, wherein rendering comprises pulling actionable UI elements from a plurality of data sources.

15. The non-transitory CRM of claim 14, wherein the actionable UI elements are collected from the plurality of data sources.

16. The non-transitory CRM of claim 9, wherein the collecting is performed by a browser-based plugin.

17. A system for generating end-to-end (E2E) tests for a user interface (UI) of a web application, the system comprising:
persistent storage; and
a computing device, comprising a processor and memory, programmed to:
receive, from a code repository, data test IDs associated with UI elements of the UI and source code;
render the UI using the source code;
collect all actionable UI elements associated with the data test IDs from the rendered UI;
generate page objects using the collected actionable UI elements;
receive a data test plan, wherein the data test plan comprises a natural language input; and
generate the E2E tests based on page objects and the data test plan, wherein the E2E tests are executable by a testing framework.

18. The system of claim 17, wherein the computing device is further programmed to:
send the E2E tests to the testing framework; and
execute the E2E tests using the testing framework to generate a set of test results.

19. The system of claim 18, wherein a first model generates the page objects and a second model generates the E2E tests.

20. The system of claim 19, wherein the E2E tests and the set of test results are used to train the second model.
